(19) United States
(12) Patent Application Publication
(10) Pub. No.: US 2017/0043801 A1
(43) Pub. Date: Feb. 16, 2017

(54) COLLAPSIBLE PUSHCHAIR FRAME OR DOLL'S PRAM FRAME

(71) Applicant: CURT WUERSTL VERMOEGENSVERWALTUNGS-GMBH & CO. KG, HOF (DE)

(72) Inventor: JAN-STEFAN WUERSTL, REGNITZLOSAU (DE)

(21) Appl. No.: 15/127,369

(22) PCT Filed: Mar. 17, 2015
(86) PCT No.: PCT/EP2015/055517

§ 371 Date: Sep. 19, 2016

(30) Foreign Application Priority Data
Mar. 17, 2014 (DE) 202014101198.6

(51) Int. Cl. B62B 7/06; B62B 9/10; B62B 7/00

(52) U.S. Cl. CPC B62B 7/06; B62B 7/006; B62B 9/102; B62B 2206/06

(57) ABSTRACT

The current invention relates to a collapsible pushchair frame or doll's pram frame, comprising at least two lateral frame bars with push bars thereon and a front wheel arrangement on the lower ends or on a bridge part joining same, two support struts, which are spaced apart from the frame bars and pivotably fixed to the lower ends thereof and have bearings on the rearward positioned lower ends opposite the articulation points for rear wheels, and a seat-insert or reclining insert, being arranged in the frame and height-adjustable. The support struts are designed as guide rails or guide rails are affixed to the support struts and/or to the frame bars, wherein holders are mounted on said guide rails to secure the seat insert or reclining insert in such a manner that same is slideably height-adjustable and lockable, wherein the centre of gravity of the inserts in the upper position is in front of that in the lower position.

The invention relates to a collapsible baby carriage or doll's pram chassis, comprising at least two lateral chassis posts, which in the erected state extend at an inclination from the bottom at the front rearwardly in upward direction, with push bars provided thereat at the upper side in prolongation and a front wheel arrangement, which is provided at the lower ends or at a bridge part connecting these, two lateral support struts, which are pivotably attached to the chassis posts at a spacing from the lower ends thereof each by way of a respective joint and which have bearings for rear wheels at their lower ends, these ends being offset rearwardly relative to the pivot points, and a seat insert or lying-down insert arranged in the chassis to be displaceable in height.

A collapsible baby carriage or doll's pram chassis of the kind according to category is known from DE 200 10 213 U1. The collapsible baby carriage or dolls' pram chassis comprises two inclined chassis posts which extend substantially parallelly to rise from the front in rearward direction and which are continuous or formed from interconnected sections, the chassis posts having push grips or a connecting push yoke at their upper ends. Two rear support struts are pivotably attached to the inclined chassis posts and form a triangle with the chassis posts in the erected state of the chassis. A seat element consisting of a seat part and a backrest part is arranged between the inclined posts as an insert and is fastened thereto. Bearing devices for the rear wheels are mounted at the lower ends of the rear support struts and a bearing device for at least one front wheel is provided at the front ends of the chassis posts or at a bridge part connecting these. An auxiliary device in the form of a support frame is mounted at the rear support struts so as to be able to receive an additional functional insert.

A collapsible baby carriage or doll's pram chassis with the same basic construction is additionally known from EP 1 281 595 A1. The pivotable support struts are held in the erected position by a U-shaped stiffly-connecting frame which consists of two longitudinal struts and a bridge part connecting the rear ends and which is arranged below the seat insert or lying-down insert between the chassis posts. The front ends of the longitudinal struts are articulated in the lower region of the carriage chassis to the chassis posts or to a connecting strut connecting these. Two coupling rods, which are pivotably attached to the longitudinal struts between the chassis posts and the support struts on the one hand and to the support struts on the other hand in each instance at the same height, produce—when the connecting rear yoke is pulled up—a movement transformation and a pivotation of the support struts towards one another in the direction of the chassis posts and conversely. A similarly constructed chassis is additionally known from DE 20 2007 011 937 U1.

Collapsible baby carriage chassis of the kind according to category are additionally known from DE 20 2013 103 448 U1, DE 20 2009 014 572 U1, EP 1 967 439 A2, WO 2012/027795 A1, CN 202463877 U and ON 201457448 U.

A carriage chassis for a baby carriage and/or doll's pram with at least two mutually spaced rear wheels and at least one front wheel is known from DE 20 2010 000 510 U1, which has at least one push bar and at least one removable insert fastenable thereto. Different baby carriage inserts are fastenable to a base element adjustable in height at the push bar. The base element can be fixed on the push bar in different height positions. Moreover, a similar construction of a height adjusting device for a seat insert at a single column of a three-wheel baby carriage is known from US 2007/0257471 A1.

A baby stroller with a foldable chassis and a child seat, which is adjustable in height by means of an adjusting device between a low baby carriage position and a high table seating position, is known from DE 297 16 952 U1. For that purpose a vertically extending adjusting device to which the child seat is fastened is provided in the carriage chassis. This adjusting device consists of at least one linear guide device arranged between the carriage chassis and the child seat. It can consist of a rack and have a detent element engaging in the toothing of the rack so as to enable locking in a defined height position.

A modular utility vehicle with a load area, which is carried by a chassis having at least one guide wheel, is known from DE 20 2012 007 192 U1. The utility vehicle can be used as a baby carriage or can be attached to a towing vehicle by means of a drawbar. In addition, a handle is provided which is operatively connected with a support wheel in such a way that this is movable by actuation of the handle from a retracted position, in which it is raised from the ground, to a support position on the ground. In one embodiment a height adjustable seat insert for a child is arranged in the load area. Through removal of the drawbar the utility vehicle can be converted into a baby carriage or into a mobile wheelchair, wherein the position and the centre of the gravity of the seat insert are displaceable by the height adjustment.

WO 2012/027795 A1 discloses a baby carriage with a securing device for preventing erroneous release of a folding mechanism. For that purpose the baby carriage comprises a first and a second release device. The first release device can comprise a belt, which is arranged below a seat insert and is connected with further components of the first release device. The seat insert cannot be shifted in the baby carriage.

U.S. Pat. No. 5,829,826 discloses a child's chair which can be brought from a highchair setting into a baby carriage setting. For that purpose, a seat part can be brought from an upper, rear position into a lower, front position.

US 2007/0194614 A1 discloses a highchair for children, in which a seat part can be brought from an upper, rear position into a lower, front position.

It has proved that when heavy children are transported in a baby carriage with a carriage chassis according to category or also when heavier objects are transported in dolls' prams and these are pushed quickly it is possible for tipping of the carriage to occur, particularly during travel around bends.

The invention accordingly has the object of enabling displacement, even in the case of a carriage chassis according to category of the centre of gravity of the insert with the child, doll or other object present therein and, in particular, in simple mode and manner without prejudicing the structure of the carriage chassis construction, so as to achieve a high degree of security against tipping.

The invention fulfils the object by design of the collapsible baby carriage or doll's pram chassis according to the teaching indicated in claim 1, in accordance with which the support struts are constructed as guide rails or guide rails extending substantially parallel thereto are mounted on the support struts and/or on the chassis posts, holders for fixing the seat insert or lying-down insert being slidably mounted on the rails to be adjustable in height and lockable at least in an upper and a lower displacement position, wherein the centre of gravity of the insert in the upper position is displaced forwardly relative to that in the lower position.

If the support struts are of unitary construction and, for example, consist of a rectangular or oval hollow section or a solid section with guide longitudinal grooves it is possible to slidably mount thereon a holder to which the insert, for example a seat insert or a lying-down insert for a small child, is attachable at the upper side or laterally. The holder is provided with locking elements so as to be able to fix this to the support strut at least in the uppermost and lowermost displacement positions. If adjustment into several height positions is desired, further detent settings can also be provided. However, it is also possible, for example, to mount an eccentric fixing lever on the holder as locking element, which lever is rotatable into a desired height position through rotation relative to a support surface of the support strut and produces, by the eccentric design, clamping through further rotation.

If, however, the support struts are divided, for example in each instance an additional joint is provided approximately in the centre or other supports or holders are provided, for example such as have been described in the introduction, a direct use of the support strut as guide rail for the holder is not suitable. Accordingly, it is alternatively provided that such a guide rail extending substantially parallelly is pivotably attached at at least one end to the support strut at the upper side and lower side or is fixedly attached at the lower end to the support strut and pivotably at the upper end to a chassis post, in particular below the joint of the support strut. The holders are positioned on the guide rails and are displaced in the same way upwardly and downwardly. The length of the guide rails is selectable and can also project beyond the chassis posts.

In order to ensure collapsing of the chassis, care has to be taken that in the case of the movement transformation with the pivot movement of the support struts in the direction of the chassis posts the guide rail does not obstruct this movement. This is excluded even when the upper bearing of the guide rail is supported on the support strut. In the case of pivotable articulation to the chassis post, in addition a slight displacement in height of the guide rail at the rotary joint has to be ensured so that collapsing of the chassis posts and the support struts can take place.

Advantageous developments of the invention are indicated in detail in the subclaims.

In one form of embodiment it is provided that push bars are mounted at the inclined chassis posts, which push bars also project beyond the backrest of a seat insert, and that mounted at the ends of the push bars are individual push grips or a connecting push yoke foldable in the middle or non-foldable. Such constructions are known. The push bars can in that case be mounted to be pivotable forwardly or rearwardly by way of fixable joints. However, they can also be rigidly connected with the chassis post.

The chassis posts themselves can be continuous chassis posts or, however, also divided chassis posts, for example they can also be divided above the pivot joint for the support struts. However, in principle this is possible also for the lower region of the chassis post. Moreover, the pivot joints between support struts and chassis post can be of different construction. It can be a simple joint or, however, also joints which intermesh by way of rim toothings and which produce a movement transformation from one part to the other.

If the chassis is so constructed that it enables lateral movement together of the chassis posts even after removal of the seat insert, either individual push grips or a foldable push yoke has or have to be provided. The same also applies to a possible bridge element which can be mounted in the lower region of the chassis posts or also provided to lie therebetween. In all cases it is ensured in the erected state of the chassis that the insert, in particular, for example, a seat insert consisting of seat surface, backrest and optionally foot support part, can be displaced in height. If the baby carriage is pushed very rapidly and the centre of gravity is displaced downwardly by the adjustment and, in particular, in the direction of the rear wheels, then it is apparent that even in the case of rapid movements around bends the baby carriage cannot tip. This adjustment possibility is particularly of advantage when the carriage chassis, by mounting a rigid front drawbar, is converted to, for example, a bicycle trailer. The function of the front wheels can in that case be disregarded.

Since the chassis posts can also be of curved construction, thus an oval structure can be provided, or, however, the structure can be rectilinear and can have a curved or wavy shape in longitudinal direction, it has to be ensured in every case that the chassis posts are arranged at such a spacing from one another that the insert is movable without obstruction not only into the upper position, but also into the lower position.

The invention is explained in more detail in the following by way of the embodiment illustrated in the drawing, in which:

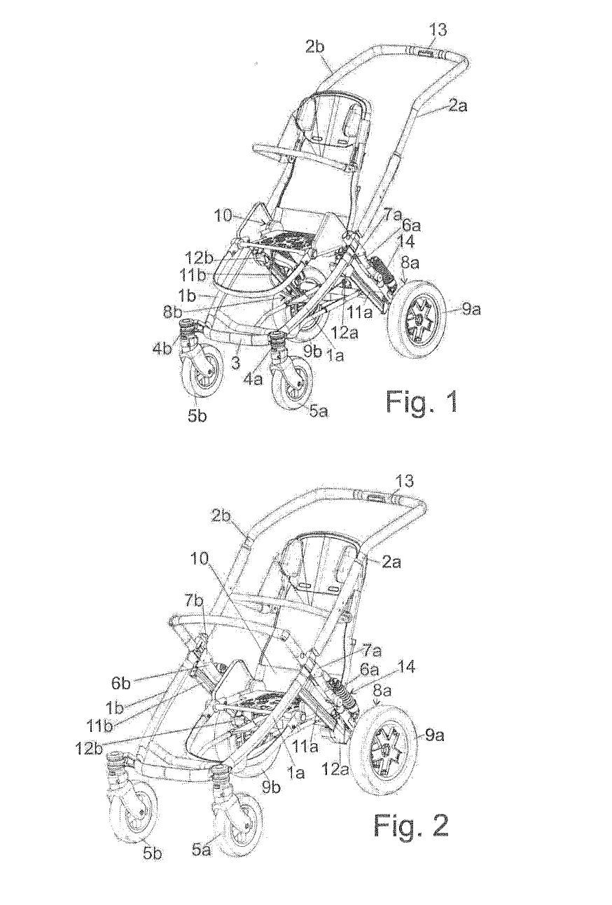

FIG. 1 shows, in an isometric illustration, a baby carriage chassis with a seat insert in highest position and

FIG. 2 shows the baby carriage chassis, which is illustrated in FIG. 1, with a seat insert in the lowest position.

The baby carriage chassis illustrated in FIGS. 1 and 2 substantially consists of the chassis posts 1a, 1b, which are arranged to extend, in the erected stale of the baby carriage chassis, to rise at an inclination in rearward direction from the bottom at the front. Push bars 2a, 2b are provided in prolongation with respect to the chassis posts 1a and 1b, which can be constructed to be continuous or divided by a joint, and are mounted in the upper sections of the chassis posts 1a, 1b to be withdrawable. The two push bars 2a, 2b are connected together by way of a push yoke 13. The lower ends of the chassis posts 1a, 1b are connected together by way of a bridge member 3 and in addition have front wheel arrangements 4a, 4b consisting of vertical bearings in each of which a bearing pin with a respective fork-shaped receptacle is pivotably mounted, the front wheels 5a and 5b being mounted in the receptacles. Pivot bearings 7a and 7b are fastened to the chassis posts 1a and 1b. Support struts 6a and 6b are attached to these pivot bearings 7a, 7b to be pivotable forwardly in the direction of the chassis posts 1a, 1b. The support struts 6a, 6b are longitudinally divided and each have a joint formed approximately in the centre and a damping spring 14 bridging over the joint. These bridging-over damping springs 14, which are fastened to the limbs of the support struts 6a, 6b, produce damping of shock loading during travel over ground with cobbles or other rough surface. The lower ends of the upper limbs of the support struts 6a, 6b are connected together by way of a bridge member. The lower limbs have mounts 8a, 8b for the rear wheels 9a and 9b.

Of significance in terms of the invention is the mounting of guide rails 11a, 11b, which are respectively attached at the lower ends to the support struts 6a, 6b and are fastened in such a way at the upper ends to a chassis post to be pivotably movable and displaceable in upward direction that when the support struts 6a, 6b are pivoted forwardly in the direction of the lower sections of the chassis posts la, lb the guide rails 11a, 11b can similarly be pivoted forwardly, which is necessary for collapsing the carriage chassis. At the upper end the guide rail can also be fastened to the respective support strut 6a, 6b. Holders 12a and 12b are arranged on the guide rails 11a, 11b to be longitudinally displaceable. These holders are provided with locking means which co-operate with the guide rails 11a and 11b, for example this can be a detent pin which is actuable by way of a button and which detents in an aperture in the guide rail under spring action and can be released from detenting by actuation of a control knob. Such apertures are provided at both the upper ends and the lower ends at the guide rails 11a and 11b for displacing and fixing the holders 12a and 12b.

A seat insert 10, which can be brought into the upper position illustrated in FIG. 1 and according to FIG. 2 can also be lowered into the lower position, is fastened to the holders 12a and 12b, whereby the centre of gravity of the seat insert 10 with the child sitting therein displaces from the front at the top in rearward direction downwardly, in which case the centre of gravity always remains between the two front wheels 5a and 5b as well as the rear wheels 9a and 9b, whereby increased security against tipping of the chassis is given even when there is rapid movement around a bend. The remaining components of the chassis are not described in more detail, since they do not have any relevance to the invention.

### REFERENCE NUMERAL LIST

1a chassis post
1b chassis post
2a push bar
2b push bar
3 bridge member
4a front wheel arrangement
4b front wheel arrangement
5a front wheel
5b front wheel
6a support strut
6b support strut
7a joint
7b joint
8a bearing
8b bearing
9a rear wheel
9b rear wheel
10 seat insert
11a guide rail
11b guide rail
12a holder
12b holder
13 push yoke
14 damping spring

1. A collapsible baby carriage or doll's pram chassis, comprising at least two lateral chassis posts, which in the erected state extend at an inclination from the bottom at the front rearwardly in upward direction, with push bars provided thereat at the upper side in prolongation and a front wheel arrangement, which is provided at the lower ends or at a bridge part connecting these, with front wheels, two lateral support struts, which are pivotably attached to the chassis posts at a spacing from the lower ends thereof each by way of a respective joint and which have bearings for rear wheels at their lower ends, these ends being offset rearwardly relative to the pivot points, and a seat insert or lying-down insert arranged in the chassis to be displaceable in height, wherein the support struts are constructed as guide rails or that guide rails mounted to extend substantially parallel thereto at the support struts and/or at the chassis posts are provided, holders for fixing the seat insert or lying-down insert being slidably mounted on the rails to be displaceable in height and lockable at least in an upper displacement position and a lower displacement position, wherein the centre of gravity of the insert in the upper position is displaced forwardly with respect to that in the lower position.

2. The collapsible baby carriage or doll's pram chassis according to claim 1, wherein push bars projecting beyond the insert are mounted on the inclined chassis posts and that individual push grips or a connecting push yoke foldable in the centre or non-foldable is or are mounted at the ends of the push bars.

3. The collapsible baby carriage or doll's pram chassis according to claim 1, wherein the holders comprise locking pins which are actuable by way of a pushbutton or a pivot lever and are detentable in detent recesses at the guide rails at least in the upper and lower displacement positions of the insert.

4. The collapsible baby carriage or doll's pram chassis according to claim 1, wherein the guide rail, when additional, is attached at least at the lower end to the support strut by way of spacers and at the upper end is pivotably attached selectably to the support strut or below the joint of the support strut to the respective chassis post.

5. The collapsible baby carriage or doll's pram chassis according to claim 1, wherein the chassis posts are arranged at such a spacing relative to one another that the insert is movable without hindrance not only into the upper position, but also into the lower position.

6. The collapsible baby carriage or doll's pram chassis according to claim 1, wherein the guide rail pivoted to the chassis post is mounted at the joint to also be displaceable in height relative to the pivot point.

7. The collapsible baby carriage or doll's pram chassis according to claim 2, wherein the guide rail pivoted to the chassis post is mounted at the joint to also be displaceable in height relative to the pivot point.

8. The collapsible baby carriage or doll's pram chassis according to claim wherein the guide rail pivoted to the chassis post is mounted at the joint to also be displaceable in height relative to the pivot point.

9. The collapsible baby carriage or doll's pram chassis according to claim 4, wherein the guide rail pivoted to the chassis post is mounted at the joint to also be displaceable in height relative to the pivot point.
